(19) United States
(12) Patent Application Publication
(10) Pub. No.: US 2007/0034007 A1
(43) Pub. Date: Feb. 15, 2007

(54) Multi-axis micromachined accelerometer

(76) Inventor: Cenk Acar, Irvine, CA (US)

Correspondence Address: EDWARD S. WRIGHT, 1100 ALMA STREET, SUITE 207, MENLO PARK, CA, 94025, US

(21) Appl. No.: 11/203,074

(22) Filed: Aug. 12, 2005

(51) Int. Cl. G01P 15/00

(52) U.S. Cl. 73/514.01

(57) ABSTRACT

Multi-axis micromachined accelerometer which, in some disclosed embodiments, has a proof mass suspended above a substrate for movement in response to acceleration along first and second axes, a first detection electrode connected to the proof mass and constrained for movement only along the first axis, and a second detection electrode connected to the proof mass and constrained for movement only along the second axis. In another embodiment, the proof mass is also movable in response to acceleration along a third axis which is perpendicular to the substrate, and a third detection electrode is mounted on the substrate beneath the proof mass for detecting movement of the proof mass in response to acceleration along the third axis. In other embodiments, two proof masses are mounted above a substrate for torsional movement about an axis perpendicular to the substrate in response to acceleration along a first axis and for rotational movement about a second axis parallel to the substrate in response to acceleration along second axis perpendicular to the substrate, a first detector having input electrodes connected to the proof masses and constrained for movement only along the first axis for detecting acceleration along the first axis, and detection electrodes mounted on the substrate beneath the proof masses for detecting rotational movement of the proof masses and acceleration along the second axis.

### BACKGROUND OF THE INVENTION

1. Field of Invention

This invention pertains generally to micromachined accelerometers and, more particularly, to an accelerometer for monitoring acceleration along two or more axes.

2. Related Art

Multi-axis micromachined accelerometers heretofore provided are subject to undesirable cross-axis sensitivity where deflection of the proof mass due to acceleration along one axis results in a slight change in the geometry of the electrodes for detecting acceleration along another axis

### OBJECTS AND SUMMARY OF THE INVENTION

It is in general an object of the invention to provide a new and improved multi-axis micromachined accelerometer.

Another object of the invention is to provide a multi-axis micromachined accelerometer of the above character which is substantially free of cross-axis sensitivity.

These and other objects are achieved in accordance with the invention by providing, in some embodiments, a multi-axis micromachined accelerometer having a proof mass suspended above a substrate for movement in response to acceleration along first and second axes, a first detection electrode connected to the proof mass and constrained for movement only along the first axis, and a second detection electrode connected to the proof mass and constrained for movement only along the second axis.

In another embodiment, the proof mass is also movable in response to acceleration along a third axis which is perpendicular to the substrate, and a third detection electrode is mounted on the substrate beneath the proof mass for detecting movement of the proof mass in response to acceleration along the third axis.

In other embodiments, two proof masses are mounted above a substrate for torsional movement about an axis perpendicular to the substrate in response to acceleration along a first axis and for rotational movement about a second axis parallel to the substrate in response to acceleration along second axis perpendicular to the substrate, a first detector having input electrodes connected to the proof masses and constrained for movement only along the first axis for detecting acceleration along the first axis, and detection electrodes mounted on the substrate beneath the proof masses for detecting rotational movement of the proof masses and acceleration along the second axis.

### BRIEF DESCRIPTION OF THE DRAWINGS

FIG. 1 is a top plan view of one embodiment of a multi-axis micromachined accelerometer incorporating the invention.

FIGS. 2-5 are top plan views of additional embodiments of a multi-axis micromachined accelerometer incorporating the invention.

FIG. 6 is a fragmentary cross-sectional view taken along line 6-6 in FIG. 5.

FIG. 7 is a view similar to FIG. 6 of another embodiment of a micromachined accelerometer incorporating the invention.

### DETAILED DESCRIPTION

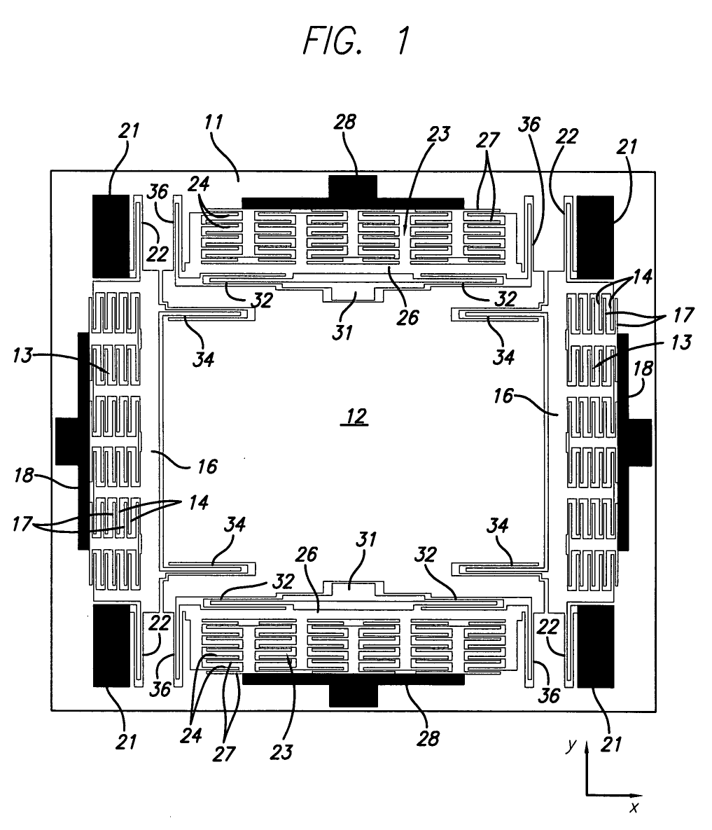

As illustrated in FIG. 1, the accelerometer has a generally planar substrate 11 which is fabricated of a suitable material such as silicon, with a generally planar proof mass 12 suspended above the substrate for movement in a plane parallel to the substrate in response to acceleration along mutually perpendicular x and y input axes which lie in the plane.

Movement of the proof mass in response to acceleration along the x-axis is monitored by capacitive detectors 13 having input electrodes or plates 14 which are mounted on movable frames 16 and interleaved with fixed electrodes or plates 17 which are mounted on frames 18 anchored to the substrate. The movable frames are suspended from anchors 21 by folded suspension beams 22 for linear movement in the x-direction. Beams 22 extend in the y-direction and are flexible in the x-direction but relatively stiff in the y and z directions so as to constrain the frames for movement in the x-direction only.

Movement of the proof mass in response to acceleration along the y-axis is monitored by capacitive detectors 23 having input electrodes or plates 24 which are mounted on movable frames 26 and interleaved with fixed electrodes or plates 27 which are mounted on frames 28 anchored to the substrate. Movable frames 26 are suspended from anchors 31 by folded suspension beams 32 for linear movement in the y-direction. Beams 32 extend in the x-direction and are flexible in the y-direction but relatively stiff in the x and z directions so as to constrain frames 26 for movement in the y-direction only.

Coupling links 34, 36 interconnect proof mass 12 with detector frames 16, 26, respectively. Coupling links 34 are folded beams which extend in the x-direction and are relatively stiff in the x and z directions but flexible in the y-direction. Hence, links 34 couple x-axis movement of the proof mass to the movable electrodes 14 of detectors 13 while permitting the proof mass to move independently of detectors 13 in the y-direction. Similarly, coupling links 36 are folded beams which extend in the y-direction and are relatively stiff in the y and z directions but flexible in the x-direction. Thus, links 34 couple y-axis movement of the proof mass to the movable electrodes 24 of detectors 23 while permitting the proof mass to move independently of detectors 23 in the y-direction.

In use, the accelerometer is installed with its x and y axes aligned with the directions in which acceleration is to be monitored. When the device is accelerated along the x-axis, links 36 flex and allow proof mass 12 to move along that axis relative to the substrate, and links 34 couple that movement to the input electrodes 14 of x-axis detectors 13, increasing the capacitance of one detector and decreasing the capacitance of the other. Suspension beams 22 permit input electrodes 14 to move in the x-direction but prevent them from moving in the y-direction, thereby decoupling detectors 13 from movement of the proof mass along they-axis. Further decoupling is provided by the flexibility of links 34 in the y-direction.

Similarly, y-axis detector 23 responds only to movement of the proof mass along the y-axis. Links 34 flex and allow proof mass 12 to move along the y-axis, and links 36 couple that movement to the input electrodes 24 of detectors 23, increasing the capacitance of one detector and decreasing the capacitance of the other. Suspension beams 32 permit input electrodes 24 to move in the y-direction but prevent them from moving in the x-direction, thereby decoupling detectors 23 from movement of the proof mass along the x-axis. Further decoupling is provided by the flexibility of links 36 in the x-direction.

Thus, the suspension beams which mount the input electrodes of the detectors and the links which interconnect the proof mass with the electrodes isolate the electrodes from orthogonal movement of the proof mass and permit the detectors to respond only to movement of the proof mass in the desired direction, thereby substantially eliminating cross-axis sensitivity.

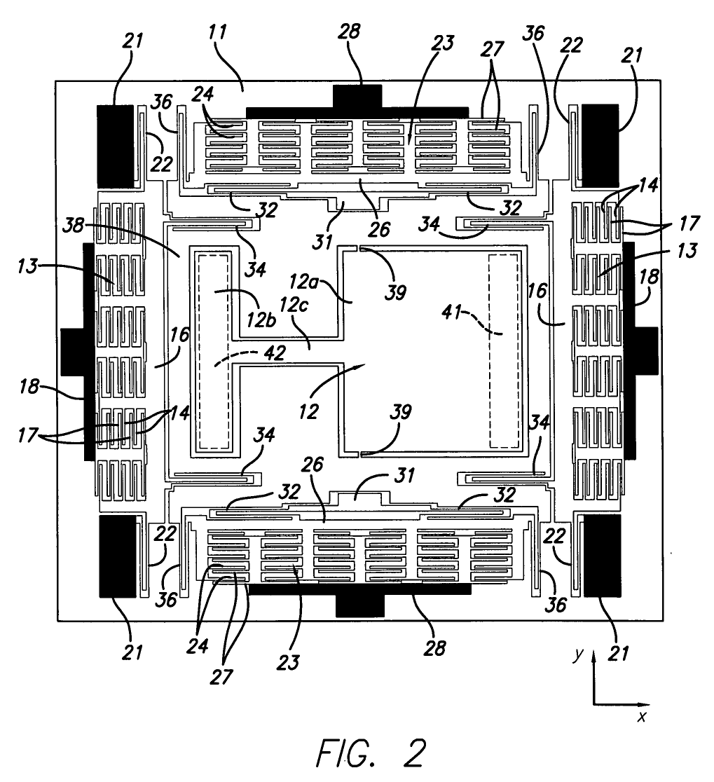

The embodiment of FIG. 2 is generally similar to the embodiment of FIG. 1, and like reference numerals designate corresponding elements in the two embodiments. In the embodiment of FIG. 2, however, the proof mass can also move in response to acceleration along a third axis, and the detector for sensing that movement is isolated from acceleration and movement along the other two axes.

Instead of being connected directly to proof mass 12 in this embodiment, coupling links 34, 36 are connected to a gimbal frame 38 which lies in the x-y plane and is free to move in the x and y directions. The proof mass has a large end section 12a and a small end section 12b on opposite sides of a relatively narrow central section 12c which extends along the x-axis. The proof mass is suspended from the gimbal frame by torsion springs or flexures 39 which are aligned along the y-axis and connected to the large end section near the inner edge of that section. The proof mass is thus mounted to the gimbal frame in an asymmetrical or imbalanced manner, and acceleration along the z-axis in a direction perpendicular to the substrate will produce an inertial moment and rotational movement of the proof mass about the y-axis. The torsion springs are relatively stiff in the x and y directions so the proof mass and the gimbal frame move together in those directions.

Sensing electrode plates 41,42 are mounted on the substrate in fixed positions beneath the end sections of the proof mass to detect rotational movement of the proof mass about the y-axis. The electrode plates form capacitors with the proof mass which change value in opposite directions as the proof mass rotates about the axis.

Operation of the embodiment of FIG. 2 is similar to that of the embodiment of FIG. 1 insofar as detecting acceleration along the x and y axes is concerned, with proof mass 12 and gimbal frame 38 moving as a unit in the x and y directions in response to acceleration along the x and y axes.

Acceleration along the z-axis causes the asymmetrically mounted proof mass to rotate about the y-axis, thereby increasing the capacitance of the capacitor formed by one of the electrode plates 41, 42 and the proof mass and decreasing the capacitance of the other. That acceleration does not affect x and y detectors 13, 23 since their input electrodes 14, 24 are constrained against movement in the z direction. Similarly, the capacitors for sensing acceleration along the z-axis are not affected by acceleration along the x and y axes because movement of the proof mass along those axes does not change the spacing between the proof mass and the electrode plates beneath it.

As in the embodiment of FIG. 1, the suspension beams which mount the input electrodes of the x and y detectors and the links which interconnect the proof mass with those electrodes isolate the electrodes from orthogonal movement of the proof mass and permit the detectors to respond only to movement of the proof mass in the desired direction. In addition, the capacitors which detect acceleration along the z-axis are not affected by movement of the proof mass in the x and y directions, and acceleration in the z direction does not affect the x and y detectors. Thus, cross-axis sensitivity is effectively eliminated between all three of the axes.

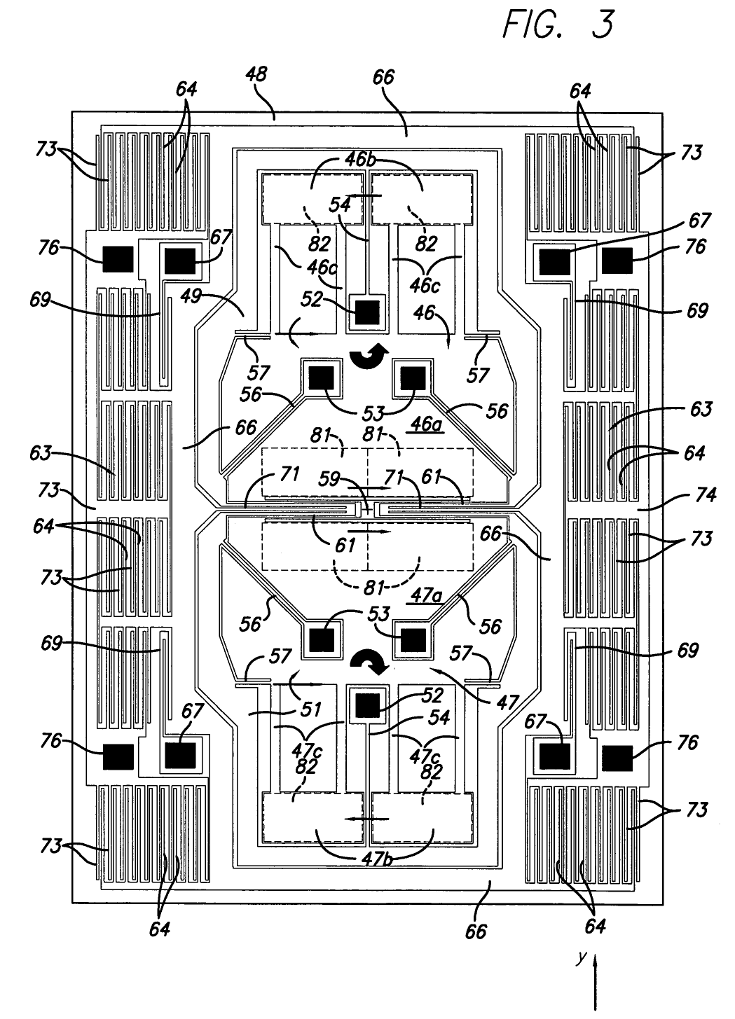

In the embodiment of FIG. 3, two generally planar proof masses 46, 47 are suspended above a substrate 48 for rotational or torsional movement about axes parallel to the x and z axes. The proof masses are mounted on U-shaped gimbals 49, 51 which are suspended from anchors 52, 53 by suspension beams or flexures 54, 56. Beams 54 extend along the y-axis, and beams 56 extend diagonally at an angle of approximately 45 degrees to the x and y axes. Those beams are relatively stiff or rigid in the z direction and constrain the gimbals for rotation about axes parallel to the z-axis.

Proof masses 46, 47 are suspended from gimbals 49, 51 by torsion springs or flexures 57 for rotational movement about axes which are parallel to the x-axis. The springs are relatively stiff or rigid in the x and y directions so that the proof masses and the gimbals move together in those directions. The proof masses have large inner sections 46a, 47a and a pair of relatively small outer sections 46b, 47b which are connected to the inner sections by rigid arms 46c, 47c that extend in the y direction. The proof masses are mounted on the gimbals in an asymmetrical or imbalanced manner, with the torsion springs being connected to the proof masses near the outer edges of the inner sections. Because of the imbalance of the masses, acceleration along the z-axis produces an inertial moment and rotational movement of the proof masses about the torsion springs.

The inner or adjacent edge portions of proof masses 46, 47 are connected together by a coupling 59 for movement in concert both along the x-axis and into and out of plane with respect to the gimbals. With the inner edges thus connected together, the two proof masses are constrained for rotation in opposite directions both about axes parallel to the x axis and about axes parallel to the z axis. The inner ends of the U-shaped gimbals are likewise connected together by couplings 61 which are relatively stiff or rigid in the x and z directions and flexible in the y direction. Those couplings constrain the inner ends of the gimbals for movement in concert in the x direction while permitting the gimbals to rotate about axes parallel to the z-axes.

Movement of the proof masses in response to acceleration along the x-axis is monitored by capacitive detectors 63 having input electrodes or plates 64 which are mounted on a frame 66 which surrounds the proof masses and gimbals and is suspended from anchors 67 by folded suspension beams 69 for linear movement in the x-direction. Beams 69 extend in the y-direction and are flexible in the x-direction but relatively stiff in the y and z directions so as to constrain the frame for movement only in the x-direction. The frame is connected to the gimbals by links 71 which extend along the x-axis and are relatively stiff in the x direction and flexible in the y direction.

Input electrodes or plates 64 are interleaved with stationary electrodes or plates 73 which are mounted on frames 74 affixed to anchors 76 on the substrate to form capacitors 63 on opposite sides of the proof masses. As in the other embodiments, movement of the proof masses in response to acceleration along the x-axis causes the capacitance of the two capacitors to change in opposite directions.

Sensing electrode plates 81, 82 are mounted on the substrate in fixed positions beneath the inner and outer sections of the proof masses to detect out-of-plane rotation of the proof masses. The electrode plates form capacitors with the proof masses which change capacitance in opposite directions as the proof masses rotate into and out of plane.

In use, the accelerometer is oriented with the x and z axes extending in the directions in which acceleration is to be detected. When the device is accelerated along the x-axis, beams 54, 56 allow gimbals 49, 51 and proof masses 46, 47 to rotate about the z-axes. The masses rotate in opposite directions, with their inner edges moving in the same direction along the x-axis. That movement is transferred to sensing frame 66 by links 71to produce changes in the capacitance of capacitors 63. Since frame 66 is constrained for movement only along the x-axis, capacitors 63 are not affected by acceleration along the y or z axes.

Acceleration along the z-axis causes proof masses 46, 47 to rotate about the x-axes. That rotation produces a change in the capacitance of the capacitors formed by the proof masses and electrode plates 81, 82. As in the embodiment of FIG. 2, the capacitance of those capacitors is not affected by acceleration along the x or y axes because movement of the proof masses along those axes does not change the spacing between the proof masses and the electrode plates beneath them.

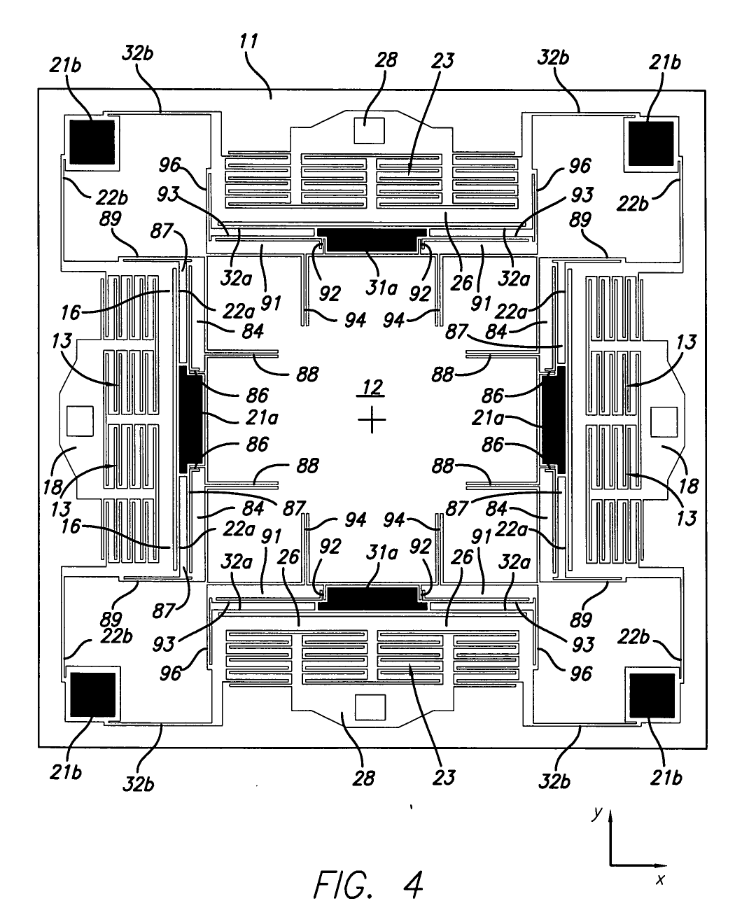

The embodiment of FIG. 4 is similar to the embodiment of FIG. 1 in that it has a generally planar proof mass 12 suspended above a substrate 11 for movement in the x and y directions, with sensing capacitors 13, 23 for detecting movement of the proof mass in those directions. The input frames 16 of capacitors 13 are suspended from anchors 21a, 21b by beams 22a, 22b which extend in the y-direction and are flexible in the x-direction but relatively stiff in the y and z directions so as to constrain frames 16 for movement in the x-direction only. The input frames 26 of capacitors 23 are suspended from anchors 31a, 21b by beams 32a, 32b which extend in the x-direction and are flexible in the y-direction but relatively stiff in the x and z directions so as to constrain frames 26 for movement in the y-direction only.

In this embodiment, deflection or movement of the proof mass in the x and y directions is applied to the sensing capacitors through levers which provide greater sensitivity by increasing or amplifying the movement. The levers which transfer the motion in the x-direction have arms 84 which extend in the y-direction and are connected to anchors 21a by flexures 86, 87 for rotation about fulcrums near the inner ends of the arms. The proof mass is connected to the lever arms near the inner ends of the arms by input links 88, and the lever arms are connected to the sensing capacitors by output links 89 which extend between the outer ends of the lever arms and the input frames 16 of the capacitors. Links 88, 89 extend in the x-direction and are rigid in that direction and flexible in the y-direction.

The levers which transfer the motion in the y-direction have arms 91 which extend in the x-direction and are connected to anchors 31a by flexures 92, 93 for rotation about fulcrums near the inner ends of the arms. The proof mass is connected to the lever arms near the inner ends of the arms by input links 94, and the lever arms are connected to the sensing capacitors by output links 96 which extend between the outer ends of the lever arms and the input frames 26 of the capacitors. Links 94, 96 extend in the y-direction and are rigid in that direction and flexible in the x-direction.

Operation and use of the embodiment of FIG. 4 is similar to that of the embodiment of FIG. 1, with the levers amplifying or increasing the movement of the input electrodes or plates of the sensing capacitors relative to the proof mass. This results from the fact that the input links are connected to the levers at points near the fulcrums, whereas the output links are connected to the levers at points removed from the fulcrums, with the increase in movement being proportional to the ratios of the distances between the links and the fulcrum.

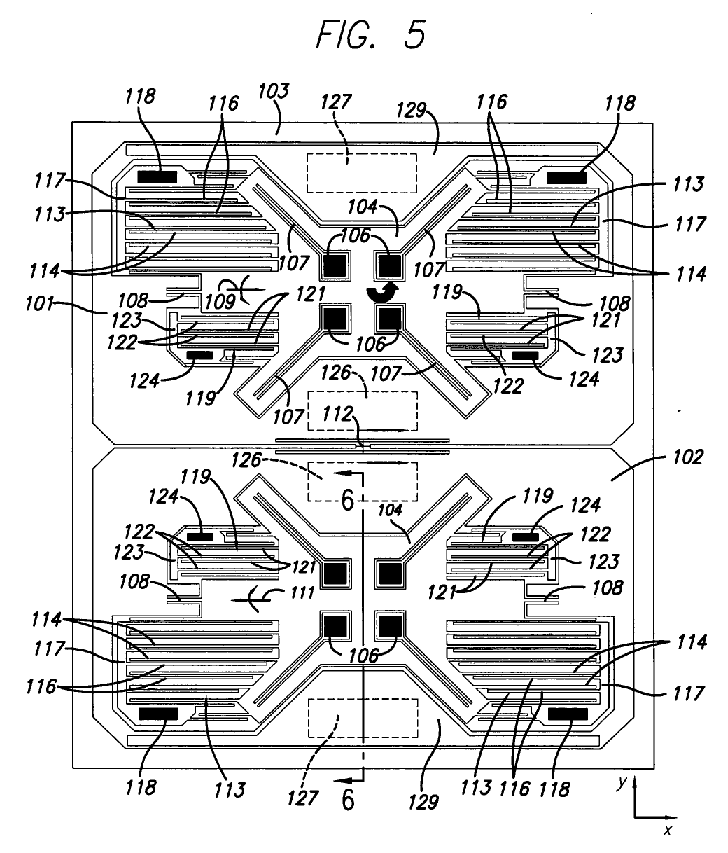

In the embodiment of FIG. 5, two generally planar proof masses 101, 102 are suspended above a substrate 103 for rotational or torsional movement about axes parallel to the x and z axes. The proof masses are mounted on inner frames 104 which are suspended from anchors 106 by suspension beams or flexures 107 which extend diagonally at an angle of approximately 45 degrees to the x and y axes. Those beams are relatively stiff or rigid in the z direction and constrain the frames for rotation about axes parallel to the z-axis.

Proof masses 101, 102 are suspended from frames 104 by torsion springs or flexures 108 for rotational movement about axes 109, 111 which are parallel to the x-axis. The springs are relatively stiff or rigid in the x and y directions so that the proof masses and the frames move together in those directions.

The inner or adjacent edge portions of proof masses 101, 102 are connected together by a coupling 112 for movement in concert both along the x-axis and into and out of plane with respect to the frames. With the inner edges thus connected together, the two proof masses are constrained for rotation in opposite directions both about axes parallel to the x axis and about axes parallel to the z axis.

Movement of the proof masses in response to acceleration along the x-axis is monitored by sensing capacitors 113 having input electrodes or plates 114 which extend in the x-direction from opposite sides of the outer portions frames 104. The input electrodes or plates are interleaved with stationary electrodes or plates 116 mounted on frames 117 affixed to anchors 118 on the substrate.

Smaller capacitors 119 are formed by movable electrodes or plates or electrodes 121 which extend from the inner portions of frames 104 and are interleaved with stationary electrodes or plates 122 mounted on frames 123 affixed to anchors 124 on the substrate.

Frames 104 and capacitors 113, 119 are located entirely within the lateral confines of proof masses 101, 102. Since capacitors 113 are larger than capacitors 119, the inner portions of the proof masses are heavier than the outer portions, and the imbalance in the masses causes the masses to rotate about axes 109, 111 when the masses are accelerated along the z-axis.

Sensing electrode plates 126, 127 are mounted on the substrate in fixed positions beneath the inner and outer portions of the proof masses to detect out-of-plane rotation of the proof masses. The electrode plates form capacitors with the proof masses which change capacitance in opposite directions as the proof masses rotate into and out of plane.

Acceleration in the x-direction produces torsional movement of the proof masses and the frames about axes perpendicular to the substrate and parallel to the z-axis. As the frames rotate, the electrodes or plates which extend from them move closer to or farther from the stationary electrodes, increasing the capacitance of the sensor on one side of each proof masse and decreasing the capacitance of the sensor on the other side. Since the inner portions of the two proof masses are connected together, the two masses rotate in opposite directions.

Acceleration in the z-direction produces out-of-plane rotational movement of the two proof masses about axes 109, 111, changing the capacitances between electrode plates 126, 127 and the proof masses. With the plates on opposite sides of the axes, the capacitances change in opposite directions, and with the inner portions of the masses connected together, the out of plane rotation of the two masses is also in opposite directions.

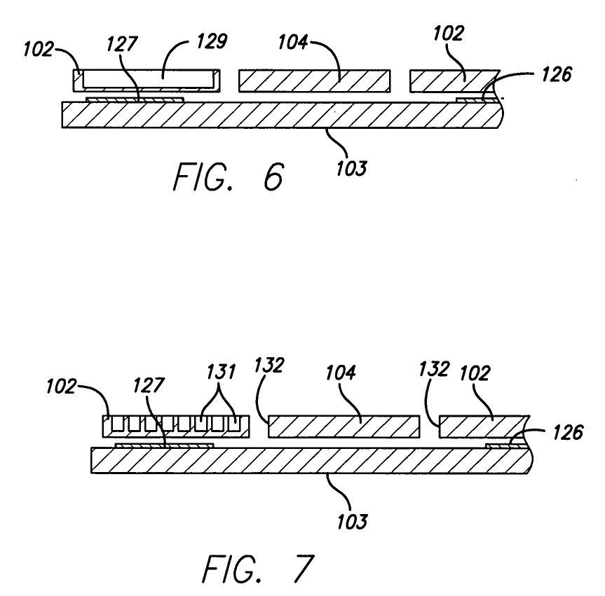

Sensitivity to acceleration along both the x and z axes can be increased by increasing the mass imbalance by removing material from the outer or lighter portions of the proof masses. Thus, in the embodiment of FIG. 5, recessed areas 129 are formed in the outer portions of the two masses, as further illustrated in FIG. 6. The recessed areas are formed by etching from the top side of the masses so as not to disturb the bottom surfaces of the masses and the capacitances between those surfaces and electrode plates 127.

Alternatively, as shown in FIG. 7, narrow trenches 131 can be formed in the outer portions of the proof masses. These trenches are formed by etching from the top side of the masses so as not to disturb the bottom surfaces. By making the trenches narrower than the gaps 132 between the proof masses and the frames and the gaps between other elements such as the capacitor electrodes or plates, the etching of the trenches will not reach the bottom surfaces, whereas the gaps are etched all the way through.

The accelerometer can be manufactured by any suitable micromachining process, with a presently preferred process being deep reactive ion etching (DRIE) of a single crystal silicon wafer. This process is compatible with a process employed in the manufacture of micromachined gyroscopes, which could reduce development time and permit the accelerometers to be fabricated at the same foundries as the gyroscopes and even on the same wafers.

The invention has a number of important features and advantages. With the detectors responsive only to acceleration in the desired directions, cross-axis sensitivity is effectively eliminated. In the embodiments of FIGS. 1 and 2, multi-axis measurements are achieved with a single proof mass, which results in significantly smaller die size than in accelerometers having a separate proof mass for each direction. In addition, the detectors have a relatively large overall plate area, which can provide a relatively high signal-to-noise ratio even in low-g applications. Sensitivity is increased by the use of levers between the proof mass and the detectors in the embodiment of FIG. 4.

In the embodiments of FIGS. 3 and 5, the gimbal and frame structures effectively decouple responses of the proof masses to acceleration along the x and z axes, thereby minimizing cross-talk, and with a sensing frame which is restricted to motion along the x-axis, the response of the x detector to accelerations in other directions is also minimized. Moreover, external angular acceleration inputs are nulled out by the symmetrical torsionally mounted proof masses which are connected together for movement in opposite directions by a rigid link.

It is apparent from the foregoing that a new and improved multi-axis micromachined accelerometer has been provided. While only certain presently preferred embodiments have been described in detail, as will be apparent to those familiar with the art, certain changes and modifications can be made without departing from the scope of the invention as defined by the following claims.

1. A multi-axis micromachined accelerometer, comprising: a proof mass suspended above a substrate for movement in response to acceleration along first and second axes, a first detection electrode connected to the proof mass and constrained for movement only along the first axis, and a second detection electrode connected to the proof mass and constrained for movement only along the second axis.

2. The accelerometer of claim 1 wherein the first and second axes are perpendicular to each other.

3. The accelerometer of claim 1 wherein the first detection electrode is suspended above the substrate by a flexible beam which extends in a direction perpendicular to the first axis, and the second detection electrode is suspended above the substrate by a flexible beam which extends in a direction perpendicular to the second axis.

4. The accelerometer of claim 1 wherein the proof mass is connected to the first detection electrode by a coupling link which is rigid along the first axis and flexible along the second axis, and the proof mass is connected to the second detection electrode by a coupling link which is rigid along the second axis and flexible along the first.

5. The accelerometer of claim 1 wherein the proof mass is connected to detection electrodes by levers which apply amplified movement of the proof mass to the electrodes.

6. The accelerometer of claim 5 wherein the levers are perpendicular to the axes of movement and are connected to the proof mass and to the detection electrodes by coupling links which are rigid along the axes and flexible laterally.

7. The accelerometer of claim 1 wherein the proof mass is also movable in response to acceleration along a third axis which is perpendicular to the substrate, and a third detection electrode is mounted on the substrate beneath the proof mass for detecting movement of the proof mass in response to acceleration along the third axis.

8. The accelerometer of claim 7 wherein the proof mass is mounted on a frame which is suspended above the substrate for movement along the first and second axes, with the proof mass being mounted asymmetrically on the frame for rotational movement about an axis parallel to the substrate.

9. A micromachined accelerometer for detecting acceleration along first and second mutually perpendicular input axes, comprising: a substrate, first and second detectors having input electrodes interleaved between fixed electrodes, flexible beams perpendicular to the first axis mounting the input electrodes of the first detector for movement only along the first axis, flexible beams perpendicular to the second axis mounting the input electrodes of the second detector for movement only along the second axis, a proof mass, coupling links which are rigid along the first axis and flexible along the second axis interconnecting the proof mass and the movable electrodes of the first detector, and coupling links which are rigid along the second axis and flexible along the first axis interconnecting the proof mass and the movable electrodes of the second detector.

10. A multi-axis micromachined accelerometer, comprising: a proof mass suspended above a substrate for movement in response to acceleration along first axis parallel to the substrate and second axes perpendicular to the substrate, a first detection electrode connected to the proof mass and constrained for movement only along the first axis for detecting acceleration along the first axis, and a second detection electrode mounted on the substrate beneath the proof mass for detecting acceleration along the second axis.

11. The accelerometer of claim 10 wherein the proof mass is constrained for linear movement in response to acceleration along the first axis.

12. The accelerometer of claim 10 wherein the proof mass is constrained for torsional movement in response to acceleration along the first axis.

13. The accelerometer of claim 10 wherein the proof mass is constrained for rotational movement about an axis parallel to the substrate in response to acceleration along the second axis.

14. A multi-axis micromachined accelerometer, comprising: a substrate, first and second detectors having input electrodes interleaved between fixed electrodes, flexible beams perpendicular to a first axis mounting the input electrodes of the first detector for movement only along the first axis, flexible beams perpendicular to a second axis mounting the input electrodes of the second detector for movement only along the second axis, a gimbal frame, coupling links which are rigid along the first axis and flexible along the second axis interconnecting the gimbal frame and the movable electrodes of the first detector, coupling links which are rigid along the second axis and flexible along the first axis interconnecting the gimbal frame and the movable electrodes of the second detector, a proof mass mounted on the gimbal frame for rotational movement about an axis parallel to the substrate in response to acceleration along an axis perpendicular to the substrate, and a detection electrode mounted on the substrate beneath the proof mass for detecting the rotational movement of the proof mass.

15. The accelerometer of claim 14 wherein the first and second axes are parallel to the substrate and perpendicular to each other.

16. A micromachined accelerometer for detecting acceleration along first and second mutually perpendicular axes, comprising: a substrate, first and second generally planar proof masses mounted side-by-side above the substrate and connected together along adjacent edge portions thereof for torsional movement about axes perpendicular to the substrate in response to acceleration along the first axis and for rotational movement about axes parallel to the substrate in response to acceleration along the second axis, a first detector having input electrodes connected to the proof masses and constrained for movement only along the first axis, and detection electrodes mounted on the substrate beneath the proof masses for detecting the rotational movement of the proof masses.

17. The accelerometer of claim 16 wherein the proof masses are mounted in gimbals for rotational movement about the axes parallel to the substrate, and the gimbals are mounted for torsional movement about the axes perpendicular to the substrate.

18. The accelerometer of claim 16 wherein the proof masses are mounted on inner frames for rotational movement about the axes parallel to the substrate, and the inner frames are mounted for torsional movement about the axes perpendicular to the substrate.

19. A micromachined accelerometer for detecting acceleration along first, and second axes, comprising: a substrate, a pair of gimbals, flexures mounting the gimbals on the substrate for torsional movement about axes perpendicular to the substrate in response to acceleration along the first axis, a pair of proof masses rotatively mounted on the gimbals for rotational movement about axes parallel to the substrate in response to acceleration along the second axis, a detector having movable input electrodes connected to the proof masses and constrained for movement only along the first axis, and detection electrodes mounted on the substrate beneath the proof masses for detecting the rotational movement of the proof masses.

20. The accelerometer of claim 19 wherein the proof masses are connected together for movement in opposite directions.

21. The accelerometer of claim 19 wherein the gimbals are connected together for movement in opposite directions.

22. A multi-axis micromachined accelerometer, comprising: a proof mass suspended above a substrate for movement in response to acceleration along first and second axes, a first detection electrode constrained for movement only along the first axis, a second detection electrode constrained for movement only along the second axis, a first lever extending in a direction perpendicular to the first axis for rotational movement about a fulcrum in a direction generally parallel to the first axis, a second lever extending in a direction perpendicular to the second axis for rotational movement about a fulcrum in a direction generally parallel to second axis, a first coupling link which is rigid along the first axis and flexible along the second axis connecting the proof mass to the first lever at a point near the fulcrum, a second coupling link which is rigid along the first axis and flexible along the second axis connecting the first detection electrode to the first lever at a point removed from the fulcrum, a first coupling link which is rigid along the second axis and flexible along the first axis connecting the proof mass to the second lever at a point near the fulcrum, and a second coupling link which is rigid along the second axis and flexible along the first axis connecting the second detection electrode to the second lever at a point removed from the fulcrum.

23. The accelerometer of claim 22 wherein the detection electrodes are interleaved between fixed electrodes.

24. The accelerometer of claim 22 wherein the first detection electrode is suspended above the substrate by flexible beams which extend in a direction perpendicular to the first axis, and the second detection electrode is suspended above the substrate by flexible beams which extend in a direction perpendicular to the second axis.

25. A micromachined accelerometer for detecting acceleration along a first axis parallel to a substrate and a second axis perpendicular to the substrate, comprising: a pair of frames mounted on the substrate for torsional movement about axes perpendicular to the substrate in response to acceleration along the first axis, a pair of generally planar proof masses mounted on the frames for torsional movement with the frames and for rotational movement about axes parallel to the substrate in response to acceleration along the second axis, sensing capacitors having input electrodes extending from the frames and interleaved with fixed electrodes mounted on the substrate for detecting torsional movement of the proof masses and frames, and detection electrodes mounted on the substrate beneath the proof masses for detecting the rotational movement of the proof masses.

26. The accelerometer of claim 25 wherein the frames and the sensing capacitors are located entirely within the lateral confines of the proof masses.

27. The accelerometer of claim 25 wherein the proof masses are configured to create a mass imbalance about the axes of rotation.

28. The accelerometer of claim 27 wherein upper portions of the proof masses are removed on one side of the axes of rotation in order to enhance the mass imbalance.
